(19) United States
(12) Patent Application Publication
(10) Pub. No.: US 2025/0139463 A1
(43) Pub. Date: May 1, 2025

(54) DYNAMIC PERSONA ASSIGNMENT FOR OPTIMIZATION OF NEAR END AND EDGE DEVICES

(71) Applicant: DELL PRODUCTS L.P., Round Rock, TX (US)

(72) Inventors: Nikhil Vichare, Austin, TX (US); Tek Basel, Austin, TX (US); Farzad Khosrowpour, Pflugerville, TX (US)

(21) Appl. No.: 18/499,830

(22) Filed: Nov. 1, 2023

(51) Int. Cl. G06N 5/022

(52) U.S. Cl. CPC G06N 5/022

(57) ABSTRACT

An information handling system stores telemetry data. A processor determines one or more types of the telemetry data. The processor determines one or more machine learning models to be executed. Each different machine learning model corresponds to a different type of telemetry data. The processor determines one or more constraints for the machine learning models. Based on the one or more constraints, the processor determines a device to execute the machine learning models. The processor executes the machine learning models in the determined device. The telemetry data is provided as inputs to the machine learning models. Based on the execution of the machine learning model, the processor determines a persona for the information handling system.

### FIELD OF THE DISCLOSURE

The present disclosure generally relates to information handling systems, and more particularly relates to assigning a dynamic persona for optimization of near end and edge devices.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a memory that may store telemetry data for the information handling system. A processor may determine one or more types of the telemetry data. The processor may determine one or more machine learning models to be executed. Each different machine learning model corresponds to a different type of telemetry data. The processor may determine one or more constraints for the machine learning models. Based on the one or more constraints, the processor may determine a device to execute the machine learning models. The processor may execute the machine learning models in the determined device. The telemetry data may be provided as inputs to the machine learning models. Based on the execution of the machine learning model, the processor may determine a persona for the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system including an information handling system, an edge device, and a cloud server according to at least one embodiment of the present disclosure;

FIG. 2 is a block diagram of components to determine a location to perform a persona detection according to at least one embodiment of the present disclosure;

FIG. 3 is a flow diagram of a method for determining a persona label for an information handling system according to at least one embodiment of the present disclosure;

FIG. 4 is a flow diagram of a method for assigning a persona to an information handling system according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

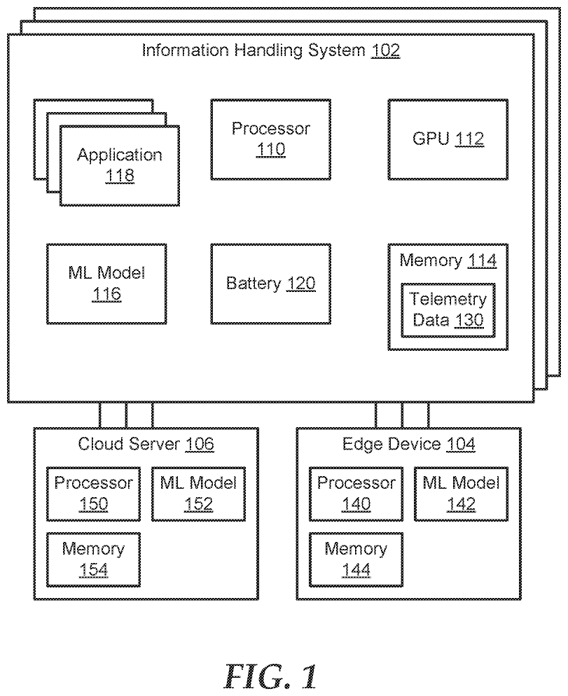

FIG. 1 illustrates a system 100 including multiple information handling systems 102, an edge device 104, and a cloud server 106 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes a processor 110, a graphics processing unit (GPU) 112, a memory 114, machine learning (ML) models 116, one or more applications 118, and a battery 120. Memory 114 may store telemetry data 130. Edge device 104 includes a processor 140, one or more ML models 142, and a memory 144. Cloud server 106 includes a processor 150, one or more ML models 152, and a memory 154. Information handling system 102 may communicate with edge device 104 and with cloud server 106. Processor 110 may communicate with memory 114 to retrieve or store data, such as telemetry data 130. Processor 110 may execute ML models 116 and applications 118. Each of information handling system 102, edge device 104, and cloud server 106 may include additional components without varying from the scope of this disclosure. System 100 may include any suitable number of information handling systems that are substantially similar to information handling system 102. Each of the information handling systems may communicate with edge device 104 and cloud server 150, and components within these information handling systems may perform substantially similar operations as will be described with respect to the components of information handling system 102.

In certain examples, each of information handling systems 102 or individuals associated with the information handling systems may be assigned a persona. In an example, more than one of information handling systems 102 may be assigned the same persona. The persona assignment may allow or enable information technology (IT) administrators to group users/information handling systems 102 by personas. This grouping of information handling systems 102 may enable actions to be performed on a persona group instead of individual information handling systems. The actions performed on a persona group may include any suitable action including, but not limited to, allocation of hardware to each information handling system 102 in the persona group. In an example, the allocation of hardware may include detail of system configurations, application catalogs, peripherals, system setting and policies, hardware, software, and support.

In certain examples, persona groups may also be used to enable capabilities for OEM applications and/or ITDMs and provide optimized experiences based on system resource utilization, application utilization, workload types, or the like. In an example, digital experience management (DEM) platforms may target automated remediations based on personas of information handling systems 102. Personas may also be utilized to detect users suitable for modern device/cloud migration and migration to cloud-based applications. Personas may also be utilized to detect users and workloads that can be dynamically migrated from device to edge to the cloud for the best experience.

In previous information handling systems, persona detection may be static, or cloud based. Static persona detection may involve persona assignment that may happen once in several months, based on a job title, user's location, or the like. Cloud-based persona detection may include persona assignments based on datasets such as application use, device type used, mobility of the user/device, or the like. In these previous information handling systems, static persona may be properly utilized for initial device type allocation. However, a system state of an information handling system does not remain static and these static defined persona may not be useful for driving automated actions for improving user experience or providing real time adaptive experiences.

Persona detection for previous information handling systems may have also been performed in a cloud server. Cloud-based persona detection/assignment may be more accurate in terms of characterizing the user/device as compared to static persona. However, most existing cloud-based persona detections are based on application usage only and do not capture system workloads, power and battery profiles, or the like. Additionally, cloud-based persona detection may include data movement problems. These data movement problems may include security issues, latency, and cost of data migration/computation.

In an example, persona detection/assignment may be improvement for real-time or near real-time use cases, such as application and system performance optimization, by a processor computing the persona with minimal latency on or near the client device, such as information handling system 102. Information handling system 102 may be improved by processor 110 calculating a multi-faceted persona using telemetry and ML models. The telemetry data and ML models may characterize system utilization, application use, user mobility, battery persona, ecosystem use characterization, or the like. In certain examples, the system utilization may include utilization of a processor, a GPU, a memory, storage, or the like. In an example, the user mobility may be based on indoor/outdoor mobility.

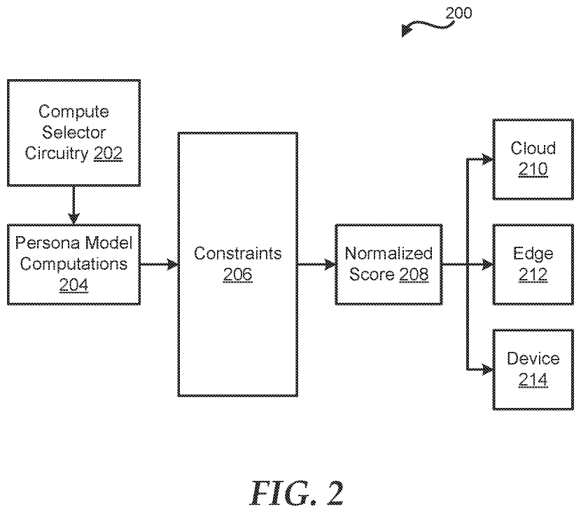

Information handling system 102 also may be improved by processor 110 determining where the persona may be computed or determined. In an example, the persona detection/assignment may be performed on information handling system 102, on edge device 104, or on cloud server 106. In certain examples, the operations to perform the persona detection/assignment and the determination of where to execute the persona assignment may be combined to further improve operations in information handling system 110. The operations of determining where the persona assignment may be performed will be described with respect to FIGS. 1 and 2.

FIG. 2 illustrate a sequence 200 to determine a location to perform a persona detection according to at least one embodiment of the present disclosure. Sequence 200 includes compute selector circuitry 202, persona model computations 204, constraints 206, normalization of scores 208, and identification of performing the persona detection in a cloud server 210, an edge device 212, or the endpoint device 214. In certain examples, the operations of 202, 204, 206, and 208 may be performed in a processor, such as processor 110 of FIG. 1. In an example, cloud server 210 may be substantially similar to cloud server 106 of FIG. 1, edge device 212 may be substantially similar to edge device 104 of FIG. 1, and endpoint device 214 may be substantially similar information handling system 102 of FIG. 1.

In an example, compute selector circuitry 202 may determine that one or more operations should be performed to compute a persona assignment for an information handling system. In certain examples, compute selector circuitry 202 may monitor the information handling system for one or more triggers for a determination that the persona assignment should be performed. The trigger may be a detection of a hardware component being added or removed, an application being installed or uninstalled, a peripheral being added or removed from the information handling system, or the like. In response to the detection of a persona assignment trigger event, compute selector circuitry 202 may cause a processor, such as processor 110 of FIG. 1, to determine persona model computations 204. When executed, persona model computations 204 may cause processor 110 to determine one or more persona models to be executed based on available data in the information handling system.

In certain examples, constraints 206 may be utilized to determine where the persona assignment operation may be performed, such as cloud server 210, edge device 212, or information handling system 214. In an example, any suitable number of constraints 206 may be placed on the execution of persona models 204. For example, constraints 206 may include an application requirement for runtime optimization constraint, a runtime system resources constraint, and a system power/battery state constraint. Constraints 206 may also include a model complexity constraint, a latency requirement for local optimization constraint, and a privacy sensitivity constraint. In an example, constraints 206 may further include a data availability constraint, a cross model interaction constraint, and a customer/IT specified requirement constraint.

In an example, each of constraints 206 may have a constraint state value assigned to the constraint. The assigned constraint state value may be set based on a preference of where the persona assignment should be performed for that constraint. In an example, the constraint state value may be set to 0, 1, or 2. In certain examples, a constraint state value of 0 may indicate that a preference for that constraint 206 is to have the models executed in cloud server 210. A constraint state value of 2 may indicate that a preference for that constraint 206 is to have the models executed in information handling system 214. A constraint state value of 1 may indicate that there is no preference of constraint 206 where the models are executed.

In certain examples, a constraint may indicate a preference for cloud server 210 for any suitable reason. For example, constraints may prefer cloud server 210 based on no strong latency needs for the ML models, the data not having privacy sensitivity, or the like. In an example, constraints may prefer information handling system 214 based on local applications being needed for inferences for runtime options, low latency needs, the data having privacy sensitivity, or the like. Based on the constraint state values, processor 110 may determine a normalized score 208 for the constraint state values. Normalized score 208 may be calculated or determined in any suitable manner. For example, normalized score 208 may be calculated using equation 1 below:

Normalized score=(sum of all state values)/(sum of maximum state values) EQ. 1

In an example, normalized score 208 may have a value between 0 and 1. The range of values for normalized score 208 may be divided into thirds. For example, a first range may be from 0 or 0.33, a second range may be from just above 0.33 to 0.66, and a third range may be from just above 0.66 to 1. If the normalized score 208 is within the first range, the persona models should be executed in cloud server 210. If the normalized score 208 is within the second range, the persona models should be executed in edge device 212. If the normalized score 208 is within the third range, the persona models should be executed in information handling system 214.

Based on the normalized score 208, processor 110 of FIG. 1 determine whether the persona assignment should be performed in cloud server 210, edge device 212, or the information handling system 214. Processor 110 may then provide the telemetry data to the determined/selected device for processing in the persona models 204. If the persona assignment is performed in cloud server 210 or edge server 212, this device may provide the persona back to information handling system 214 for storage. Information handling system 214 may also provide the assigned persona to a server associated with an IT administrator. In an example, the personas for multiple information handling systems 102 may be provided to edge device 104. These different information handling system persons may be combined into a federated persona on edge device 104 for common users in workgroups or corporations. This federated persona may make integrated technology demand management (ITDM) policy management and feature management easier.

Referring back to FIG. 1, a corresponding processor 110, 140, or 150 may perform one or more ML models to determine a persona for information handling system 102. For example, a CPU usage persona may be determined based on characteristics of system workloads to characterize system level CPU usage over time. In an example, the persona model may use multiple telemetry variables, such as an average CPU usage, a thread count, C0 state percentage, >80% CPU usage, a processor queue length, or the like. Processor 110 may use the telemetry data to train the model to classify utilization levels into any suitable number of classes, such as normal, elevated, and high. In certain examples, devices that are classified in the high class may be core-count limited devices and have smart tag for frequency limited devices. In an example, processor 110 may execute ML model 116 to place each application in the usage data into one of multiple categories. In certain examples, training data for ML model 116 may be prepared manually. After training ML model 116, processor 110 may execute the ML model to determine an application usage persona of information handling system 102.

In certain examples, smart tags may be based on user characterizations. In an example, the characterization may be based the telemetry data in the information handling system, such as user behavior, preferences, workloads, performance, system health, sustainability, well-being, or the like. In certain examples, concise labels may be inferred from user data and models. In these examples, simple heuristic data may be converted into complex deep learning models. In an example, the persona assignments may be used for a variety of use cases, such as recommendation, remediation, IT operations, endpoint intelligence, experience management, platform software, integrated diagnostics, or the like. In certain examples, smart tags may be combined with other tags or used as features in artificial intelligence (AI) models. Each smart tag may have a life cycle and may improve with data for deeper characterizations.

As described herein, information handling system 102, edge device 104, and cloud server 106 may combine to provide a multifaceted persona detection for the information handling system based on different aspects of the user and system. Processor 110 may determine whether the persona detection is performed in information handling system 102, edge device 104, or cloud server 106. In certain examples, information handling system 102, edge device 104, and cloud server 106 may implement flexibility to combine different personas using dynamic grouping. In an example, the persona decisions may be performed in information handling system 102 to enable system configuration decisions in real time.

In an example, the personas for different information handling systems 102 may enable IT administrators to deploy hardware, applications, peripherals, settings, policies, and entitlements to all of the information handling systems with the same persona. In certain examples, IT tasks may be automated based on persona groups. In an example, ITDMs may fine-tune persona classifications. For example, the persona of information handling system 102 may be a remote developer persona based on tools being used is a high level, mobility of the information handling system is a low level, performance utilization is a high level. Processor 110 may detect a persona suitable for modern device/cloud migration, and detect an application usage persona for migration to modern applications.

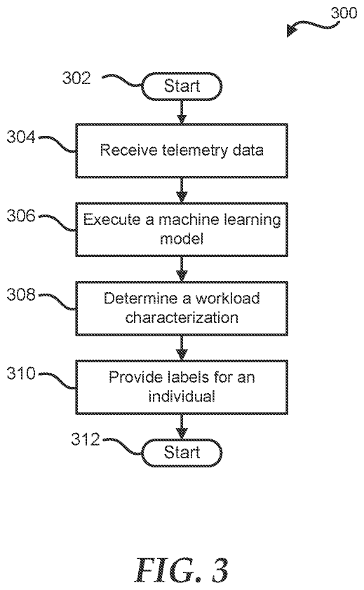

FIG. 3 is a flow diagram of a method 300 for determining a persona label for an information handling system according to at least one embodiment of the present disclosure, starting at block 302. In an example, method 300 may be performed by any suitable component including, but not limited to, processor 102 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At block 304, telemetry data is received. In an example, the telemetry data may be received from any suitable source and may be any suitable data for an information handling system. For example, the data source for the telemetry data may include, but is not limited to, internal application programming interfaces (APIs), peripheral devices, power devices, applications, and storage devices. The telemetry data may include, but is not limited to, application usage and foreground applications, features grouped by device, BMU and power data, location and mobility of the information handling system, and API access to select fields in a configuration manager/workday/other.

At block 306, a ML model is executed. In certain examples, the ML models may perform one or more suitable operations on the telemetry data received at an input terminal and provide outcomes and a label at an output terminal of the ML model. The outcomes may be a workload characterization for the information handling system. In an example, any suitable ML model may be executed, and different ML models may be executed for different telemetry data. For example, the ML model may be an application type classification model to process application usage and foreground applications telemetry data. Module specific ML models may be executed for feature data, such as data associated with a processor, a memory, a disk drive, and a graphic processing unit. A classification model may be executed for BMU and power data, such as charge/discharge profiles of a battery or other power source in the information handing system. In certain examples, a ML model may determine a context of multi-networks per user based on the location and mobility telemetry data. Another ML model may determine the peripherals used by an application, based on the location of the information handling system, or the like.

At block 308, a workload characterization is determined. In an example, the workload characterization may be provided as an output of the ML model executed in block 306. In certain examples, an application usage characterization may be provided from the application type classification model. The module specific ML models may provide processor, memory, storage, and GPU smart tags. In an example, the classification model may provide a battery runtime and persona smart tag as a workload characterization. A context of multi-networks per user may be used to provide network switching score workload characterization. The peripheral model may output peripheral context. In an example, the API telemetry data may be combined as an organization or team characterization.

At block 310, labels for an individual are provided, and the flow ends at block 312. In an example, the label may be based on the workload characterizations from block 308. In an example, the label may identify a type of work for the individual associated with the information handling system. In certain examples, the label may be utilized to determine different configuration recommendations for the information handling system. In an example, the recommendation may include, but is not limited to, hardware system configurations, hardware subsystem configurations, software recommendations, peripheral recommendations, and connectivity recommendations.

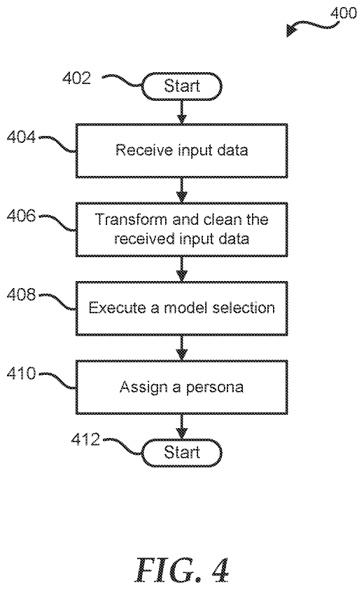

FIG. 4 is a flow diagram of a method 400 for assigning a persona to an information handling system according to at least one embodiment of the present disclosure, starting at block 402. In an example, method 400 may be performed by any suitable component including, but not limited to, processor 102 of FIG. 1. It will be readily appreciated that not every method step set forth in this flow diagram is always necessary, and that certain steps of the methods may be combined, performed simultaneously, in a different order, or perhaps omitted, without varying from the scope of the disclosure.

At block 404, input data is received. In an example, the data may be any suitable data associated with an information handling system. For example, the data may include a latency requirement for the persona assignment, an amount of resource utilization needed for the assignment, and data associated with components/operations of the information handling system. In an example, the latency requirement data may indicate that the latency requirement is high, high/medium, medium, medium/low, or low. Similarly, the resource utilization data may indicate that the utilization should be high, medium, or low.

At block 406, the received input data is transformed. In an example, the data may be transformed into any suitable data format that may be utilized by a ML model. At block 408, an ML model is selected and executed. In certain examples, the ML model may be selected based on the data type received. For example, if the data type is application usage telemetry data, an application classification model may be selected and executed. If the data is battery management data, a battery runtime usage model may be selected and executed. In an example, hardware utilization telemetry data may be input to a statistics and ML model. Data associated with peripherals may be provided as inputs to rule-based models. If the data is user directory information, the model may be a rule-based title/business unit model.

At block 410, a persona is assigned, and the flow ends at block 412. The personas may be any suitable identifiers for an individual associated with the information handling system. For example, the persona types may be application usage personas, battery usage personas, hardware usage personas, ecosystem/device usage personas, job profile personas, or the like. If the information handling system is associated with a technology company the personas may include, but are not limited to, a business professional, a mobile business professional, an outside sales individual, an executive, a presales/field support/customer support, a graphics designer/product engineer/development, a desk-based business professional, and a desk-based development and technical engineer. In certain examples, each of the different personas may have a different hardware, software, and peripheral configuration within the corresponding information handling system.

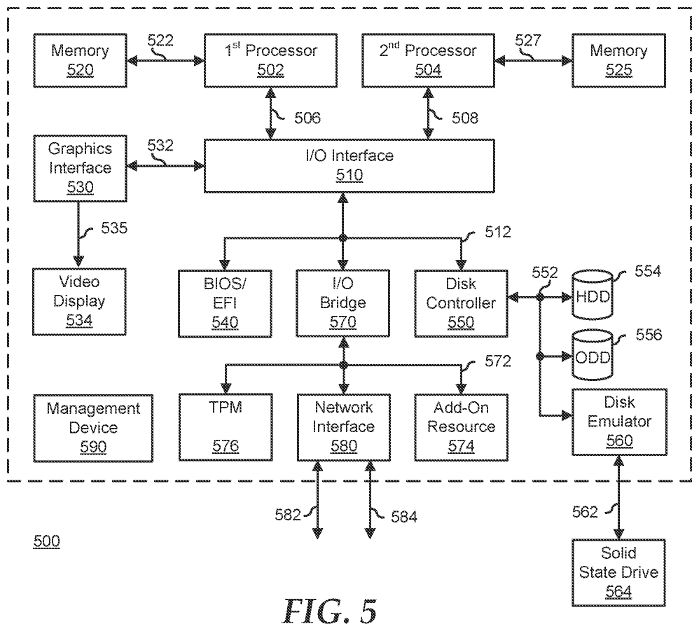

FIG. 5 shows a generalized embodiment of an information handling system 500 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 4394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store telemetry data for the information handling system; and
a processor to communicate with the memory, wherein the processor to:
determine one or more types of the telemetry data;
determine one or more machine learning models to be executed, wherein each different machine learning model corresponds to a different type of telemetry data;
determine one or more constraints for the machine learning models;
based on the one or more constraints, determine a device to execute the machine learning models, wherein the machine learning models are executed in the determined device, wherein the telemetry data is provided as inputs to the machine learning models; and
based on the execution of the machine learning models, determine a persona for the information handling system.

2. The information handling system of claim 1, wherein each of the constraints includes a constraint state value indicating whether an associated machine learning model should be executed in the information handling system, a cloud server, or an edge device.

3. The information handling system of claim 2, wherein the processor further to: based on the constraint state values, determine a normalized score for the constraints.

4. The information handling system of claim 3, wherein the determination of the device to execute the machine learning models is based on the normalized score.

5. The information handling system of claim 1, wherein a different label is provided as an output from a different one of the machine learning models.

6. The information handling system of claim 5, wherein the persona for the information handling system is based on a combination of the different labels.

7. The information handling system of claim 1, wherein one of the constraints is a latency requirement for optimization within the information handling system.

8. The information handling system of claim 1, wherein an update to the information handling system is based on the persona of the information handling system.

9. A method comprising:
determining, by a processor of an information handling system, one or more types of telemetry data;
determining one or more machine learning models to be executed, wherein each different machine learning model corresponds to a different type of telemetry data;
determining one or more constraints for the machine learning models;
based on the one or more constraints, determining, by the processor, a device to execute the machine learning models;
executing the machine learning models in the determined device, wherein the telemetry data is provided as inputs to the machine learning models; and
based on the executing of the machine learning models, determining a persona for the information handling system.

10. The method of claim 9, wherein each of the constraints includes a constraint state value indicating whether an associated machine learning model should be executed in the information handling system, a cloud server, or an edge device.

11. The method of claim 10, wherein the method further comprises: based on the constraint state values, determine a normalized score for the constraints.

12. The method of claim 11, wherein the determining of the device to execute the machine learning models is based on the normalized score.

13. The method of claim 9, wherein a different label is provided as an output from a different one of the machine learning models.

14. The method of claim 13, wherein the persona for the information handling system is based on a combination of the different labels.

15. The method of claim 9, wherein one of the constraints is a latency requirement for optimization within the information handling system.

16. The method of claim 9, wherein an update to the information handling system is based on the persona of the information handling system.

17. An information handling system comprising:
a memory to store telemetry data for the information handling system; and
a processor to:
determine one or more types of the telemetry data;
determine one or more machine learning models to be executed, wherein each different machine learning model corresponds to a different type of telemetry data;
determine one or more constraints for the machine learning models;
determine a normalized score for the one or more constraints;
based on the normalized score, determine a device to execute the machine learning models, wherein the machine learning models are executed in the determined device, and the telemetry data is provided as inputs to the machine learning models; and
based on the execution of the machine learning models, determine a persona for the information handling system, wherein an update to the information handling system is based on the persona of the information handling system.

18. The information handling system of claim 17, wherein a different label is provided as an output from a different one of the machine learning models.

19. The information handling system of claim 18, wherein the persona for the information handling system is based on a combination of the different labels.

20. The information handling system of claim 17, wherein each of the constraints includes a constraint state value indicating whether an associated machine learning model should be executed in the information handling system, a cloud server, or an edge device.
